(19) United States
(12) Patent Application Publication
(10) Pub. No.: US 2025/0391602 A1
(43) Pub. Date: Dec. 25, 2025

(54) MAGNETIC CORE STRUCTURE AND LEAKAGE INDUCTANCE CONTROL METHOD FOR MAGNETIC INTEGRATED HIGH-FREQUENCY TRANSFORMER

(71) Applicant: Shandong University, Jinan (CN)

(72) Inventors: Wenliang Zhao, Jinan (CN); Haibo Ding, Jinan (CN); Ning Wang, Jinan (CN); Chengwu Diao, Jinan (CN); Zhiwei Sui, Jinan (CN); Baolu Wei, Jinan (CN)

(73) Assignee: Shandong University, Jinan (CN)

(21) Appl. No.: 19/305,462

(22) Filed: Aug. 20, 2025

(30) Foreign Application Priority Data
Aug. 21, 2024 (CN) 202411149921.4

(51) Int. Cl. H01F 27/34; H01F 27/24; H01F 27/28; H01F 27/38

(52) U.S. Cl. CPC H01F 27/346; H01F 27/24; H01F 27/2823; H01F 27/38

(57) ABSTRACT

This disclosure openly provides a magnetic core structure and a leakage inductance control method for a magnetic integrated high-frequency transformer, which involves the technical field of high-frequency transformers, including two square magnetic core edge columns, the first main magnetic core column, the second main magnetic core column, the first secondary magnetic core column and the second secondary magnetic core column; the two square magnetic core edge columns are arranged in parallel, the first main magnetic core column and the second main magnetic core column are placed in parallel and vertically in a middle of the two square magnetic core edge columns, and two ends of the first main magnetic core column and the second main magnetic core column are fixedly connected to two ends of the two square magnetic core edge columns respectively.

### TECHNICAL FIELD

This disclosure involves the technical field of high-frequency transformers, specifically, a magnetic core structure and a leakage inductance control method for a magnetic integrated high-frequency transformer.

### BACKGROUND

The statement of this part only provides the background technical information related to this disclosure, which does not necessarily constitute prior technology.

In recent years, with the increasing use of renewable energy and the advancement of power electronics technology, the number of power converters required by the power supply system is growing, and their role is to facilitate the transmission and conversion of electric energy. As an important index in a power converter system, power density has been widely studied. In order to reduce the volume of the converter and realize the miniaturization of the converter, the magnetic integration scheme may be used to reduce the volume of the converter.

Transformers in traditional power electronic devices generally use multiple ferrites or other high-performance magnetic cores, which have been widely used because of their simple design principles and easy fabrication. For multi-transformer applications, the integration of transformers is of great significance to improve the power density and operating efficiency of power electronic devices.

As an important factor for optimizing high-frequency transformers, the leakage inductance not only helps to improve the energy transmission efficiency, but also is of great significance for the stability and reliability of high-frequency circuits. Meanwhile, the leakage inductance of the high-frequency transformer is adjusted to meet the needs of the resonant circuit of the soft switching power supply.

However, there is little technology available on the leakage inductance adjustment of a high-frequency transformer. Changing the air gap of the magnetic core is mainly used in the traditional method when it refers to adjusting the leakage inductance of the high-frequency transformer, but the air gap of the magnetic core will increase the loss, the magnetic field will be unstable, thereby producing noise, and hurting the performance and stability of the high-frequency transformer.

### SUMMARY

In order to solve the above problems, this disclosure proposes a magnetic core structure and a leakage inductance control method for a magnetic integrated high-frequency transformer, and designs a magnetic integrated core structure. Based on the magnetic integrated core structure, the leakage inductance of the magnetic integrated high-frequency transformer is accurately modulated by adjusting the number of turns of the secondary auxiliary winding, so as to avoid the negative effects of loss, heat, and noise when the air gap is opened on the magnetic core.

In some embodiments, the following technical schemes are adopted in this disclosure:
A magnetic core structure of a magnetic integrated high-frequency transformer, including:
two square magnetic core edge columns, a first main magnetic core column, a second main magnetic core column, a first secondary magnetic core column and a second secondary magnetic core column; the two square magnetic core edge columns are arranged in parallel, the first main magnetic core column and the second main magnetic core column are placed in parallel and vertically in a middle of the two square magnetic core edge columns, and two ends of the first main magnetic core column and the second main magnetic core column are fixedly connected to two ends of the two square magnetic core edge columns respectively;
the two square magnetic core edge columns are hollowed out in the middle; the first magnetic core column and the second secondary magnetic core column are placed on both sides of the hollow in parallel and vertically, and are fixedly connected to the two square magnetic core edge columns, windings are arranged on the two main magnetic core columns and the two secondary magnetic core columns; the square magnetic core edge columns are fixed with the main and secondary magnetic core columns as a magnetic flux channel connecting the main and secondary magnetic core columns.

In some embodiments, the first main magnetic core column, the second main magnetic core column, the first secondary magnetic core column, the second secondary magnetic core column and the two square magnetic core edge columns all use isotropic magnetic materials, so that the magnetic core has the same magnetic permeability in different directions, and the magnetic permeability of the main magnetic core column and the secondary magnetic core column is greater than that of the square magnetic core edge column.

In some embodiments, cross-sectional areas of the first main magnetic core column, the second main magnetic core column, the first secondary magnetic core column, and the second secondary magnetic core column are the same.

In some embodiments, a width of the square magnetic core edge column is equal to the widths of the first main magnetic core column, the second main magnetic core column, the first secondary magnetic core column, and the second secondary magnetic core column.

In some embodiments, a first primary winding and a first secondary winding of a first transformer are wound on the first main magnetic core column, and a second primary winding and a second secondary winding of a second transformer are wound on the second main magnetic core column; the two groups of primary windings and secondary windings are overlapped and placed in a vertical direction of the two main magnetic core columns.

In some embodiments, the first secondary winding and the second secondary winding are connected in series to the first secondary auxiliary winding and the second secondary auxiliary winding respectively; the first secondary auxiliary winding and the second secondary auxiliary winding are overlapped and arranged on the secondary magnetic core column in a whole, which is overlapped with each other in the vertical direction of the secondary magnetic core column.

In some embodiments, the winding directions of the first secondary auxiliary winding and the second secondary auxiliary winding are opposite to those of the first secondary winding and the second secondary winding.

In some embodiments, the form of the winding wires is copper foil or Litz wire.

In some embodiments, the following technical schemes are adopted in this disclosure:
a leakage inductance control method for the magnetic core structure of the magnetic integrated high-frequency transformer includes:
a magnetic flux leakage reactance X_{σ} generated by the first secondary auxiliary winding and the second secondary auxiliary winding is calculated as:

$${X}_{σ} = 2 π {fN}_{a}^{2} \frac{{μ}_{0} {A}_{0}}{{l}_{0}}$$

where f is an excitation frequency of the high-frequency transformer, Nₐ denotes coil turns of the secondary auxiliary winding, μ₀ is a permeability of the air, μ₀=4π×10⁻⁷ H/m, A₀ and l₀ are a cross-sectional area of the air magnetic circuit and a length of the air magnetic circuit, respectively.

In some embodiments, by adjusting the number of turns of the secondary auxiliary winding, a leakage magnetic flux of the secondary auxiliary winding in the hollow of the magnetic core is adjusted, and an accurate modulation of the leakage inductance is realized; the first primary winding turn of the first transformer is Nₚ₁, the first secondary winding turn is Nₛ₁, and the first auxiliary winding turn is Nₐ₁; the secondary auxiliary winding is mainly used to provide leakage inductance, which has little effect on the magnetic flux flowing through the primary winding and the secondary winding in the magnetic core; according to Nₚ₁/(Nₛ₁+Nₐ₁)≈Nₚ₁/Nₛ₁, the voltage ratio of the first transformer is approximately Nₚ₁/Nₛ₁; the second transformer is the same.

Compared with existing technologies, the beneficial effects of this disclosure are:

In this disclosure, a magnetic core structure and a leakage inductance control method for the magnetic integrated high-frequency transformer are disclosed. Two square magnetic core edge columns are set as a structure with a gap in the middle; the first secondary magnetic core column and the second secondary magnetic core column are placed on both sides of the hollow; two main magnetic core columns and two secondary magnetic core columns are equipped with windings; the square magnetic core edge column is fixed with the main and secondary magnetic core columns as the magnetic flux channel connecting the main and secondary magnetic core columns. Under this magnetic integrated core structure, the leakage inductance of the magnetic integrated high-frequency transformer may be accurately modulated by adjusting the number of turns of the secondary auxiliary winding, which effectively avoids the negative effects of loss, heat, and noise caused by opening an air gap on the magnetic core.

The magnetic core structure and leakage inductance control method for the magnetic integrated high-frequency transformer disclosed in this disclosure may effectively improve the power density and efficiency of the high-frequency transformer, reduce the loss of the transformer, and improve the reliability and miniaturization of the power electronic device by realizing a smaller magnetic device volume. Meanwhile, the secondary auxiliary winding is wound on the overall secondary magnetic core column, and the leakage inductance may be accurately adjusted by changing the number of turns of the secondary auxiliary winding.

In this disclosure, a magnetic core structure and a leakage inductance control method of a magnetic integrated high-frequency transformer are disclosed. The first main magnetic core column, the second main magnetic core column, the first secondary magnetic core column, the second secondary magnetic core column and two square magnetic core edge columns all use isotropic magnetic materials to ensure that the magnetic core has the same magnetic permeability in different directions, and the magnetic permeability of the main magnetic core column and the secondary magnetic core column is much larger than the magnetic permeability of the square magnetic core edge column, so as to realize the decoupling integration of the first transformer and the second transformer, so as to realize the smaller magnetic core volume, and effectively improve the power density and efficiency of the high-frequency transformer. Specifically, by using the permeability of the main magnetic core column and the auxiliary core column, which is greater than the permeability of the square magnetic core edge column, the main and auxiliary core columns form a low reluctance magnetic circuit. For the first transformer, the magnetic flux generated by the first primary winding is mainly distributed along the low reluctance magnetic circuit, and the magnetic flux is formed along the direction of the first main magnetic core column—the upper core edge column—the two auxiliary core columns—the lower square magnetic core edge column—the first main magnetic core column. The second transformer is the same. Therefore, the decoupling integration of two transformers is realized on the magnetic core of this structure.

### BRIEF DESCRIPTION OF THE DRAWINGS

The drawings attached to the instructions that form part of this disclosure are used to provide a further understanding of this disclosure. The schematic examples and explanations of this disclosure are used to explain this disclosure, which does not constitute an improper limitation of this disclosure.

FIG. 1 is a side view of the structure of the high-frequency transformer in the embodiment of this disclosure;

FIG. 2 is a front view of the structure of the high-frequency transformer in the embodiment of this disclosure;

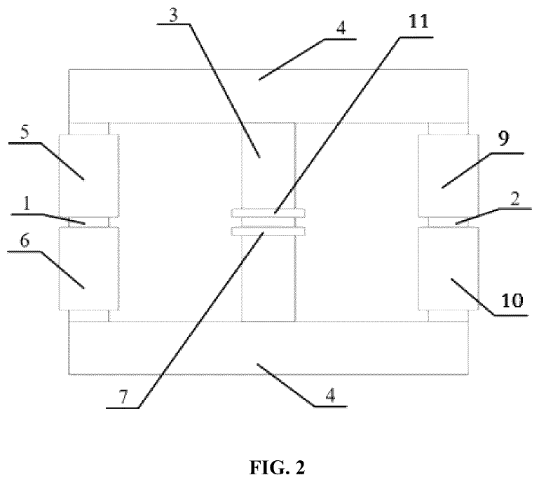

FIG. 3 is a top view of the structure of the high-frequency transformer in the embodiment of this disclosure;

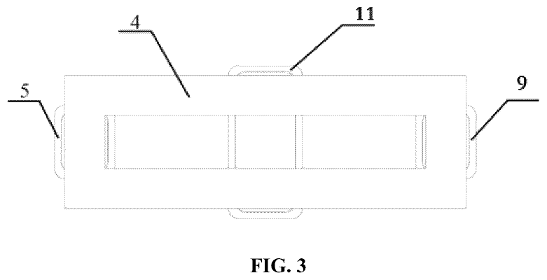

FIG. 4 is a schematic diagram of the magnetic core structure in the embodiment of this disclosure;

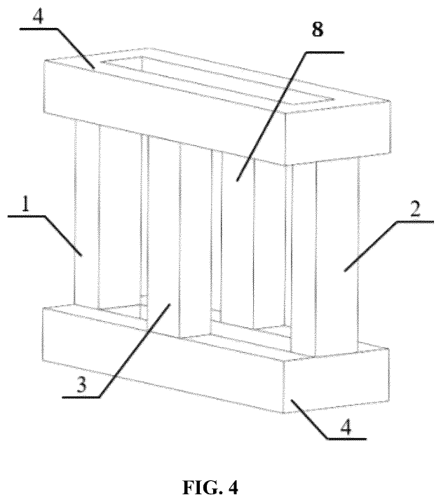

FIG. 5 is a section diagram of the high-frequency transformer in the embodiment of this disclosure;

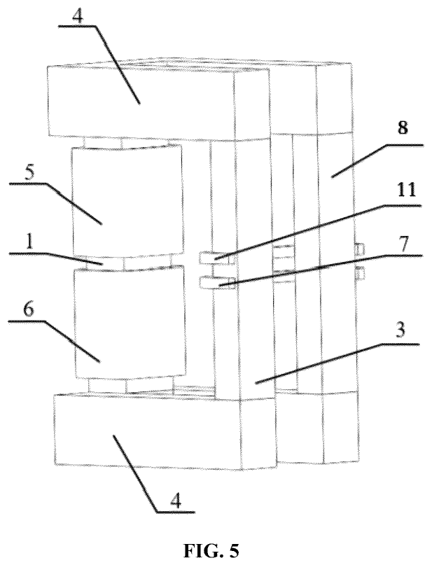

FIG. 6 is a circuit schematic diagram of the first transformer of the high-frequency transformer in the embodiment of this disclosure;

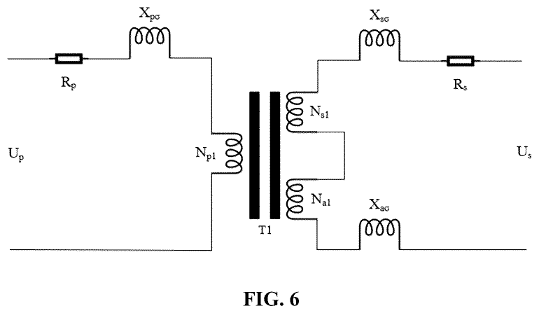

FIG. 7 is a schematic diagram of the magnetic flux principle of the magnetic core of the high-frequency transformer in the embodiment of this disclosure;

FIG. 8 is a schematic diagram of the leakage magnetic flux of the secondary auxiliary winding of the high-frequency transformer in the embodiment of this disclosure.

Among them, 1, the first main magnetic core column; 2, the second main magnetic core column; 3, the first secondary magnetic core column; 4, the square magnetic core edge column; 5, the first primary winding; 6, the first winding; 7, the second secondary auxiliary winding; 8, the second secondary magnetic core column; 9, the second primary winding; 10, the second winding; 11, the first secondary auxiliary winding.

Among them, Uₚ, Nₚ₁, Rₚ, X_{pσ}, Uₛ, Nₛ₁, Nₐ₁, Rₛ, X_{sσ}, X_{aσ} are the input voltage, primary winding turns, primary winding resistance, primary winding leakage reactance, output voltage, secondary winding turns, secondary auxiliary winding turns, secondary winding resistance, secondary winding leakage reactance, secondary auxiliary winding leakage reactance of the first transformer, respectively.

### DETAILED DESCRIPTION OF THE EMBODIMENTS

The following is a further explanation of this disclosure in combination with the attached figures and implementation examples.

It should be noted that the following details are illustrative and are intended to provide further clarification of this disclosure. Unless otherwise specified, all technical and scientific terms used herein have the same meaning as those commonly understood by ordinary technicians in the technical fields to which this disclosure relates.

It is important to note that the term used here is only intended to describe the specific implementation, not intended to limit the example implementation based on this disclosure. As used here, the singular form is also intended to include the plural form unless explicitly stated in the context. In addition, it should be understood that when the terms “include” and/or “including” are used in this specification, they indicate the presence of features, steps, operations, devices, components, and/or combinations of them.

### Example 1

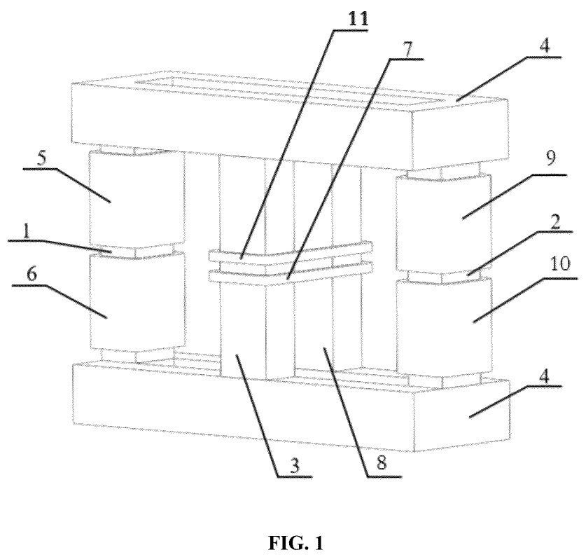

A magnetic core structure of a magnetic integrated high-frequency transformer is provided in an embodiment disclosed in this disclosure. On the basis of realizing a smaller magnetic device volume, the power density and efficiency of the high-frequency transformer are effectively improved, the transformer loss is reduced, and the reliability of the power electronic device is improved and miniaturized. As shown in FIG. 1, it includes two square magnetic core edge columns 4, the first main magnetic core column 1, the second main magnetic core column 2, the first secondary magnetic core column 3, and the second secondary magnetic core column 8. The two square magnetic core edge columns 4 are placed up and down in parallel, and the first main magnetic core column 1 and the second main magnetic core column 2 are placed in parallel and vertically in the middle of the two square magnetic core edge columns 4. The two ends of the first main magnetic core column 1 and the second main magnetic core column 2 are respectively fixedly connected to the two ends of the two square magnetic core edge columns 4. The first main magnetic core column 1 and the second main magnetic core column 2 are arranged between the two square magnetic core edge columns 4, which are parallel to each other, and are fixed at both ends.

The two square magnetic core edge columns 4 are set in the middle hollow, and there is a gap in the middle of each square magnetic core edge column 4. The first secondary magnetic core column 3 and the second secondary magnetic core column 8 are placed in parallel and vertically on both sides of the hollow, and are fixedly connected to the two square magnetic core edge columns 4. Two main magnetic core columns and two secondary magnetic core columns are equipped with windings. The square magnetic core edge column is fixed with the main and secondary magnetic core columns as the magnetic flux channel connecting the main and secondary magnetic core columns.

Further, the winding includes the winding of the first transformer and the winding of the second transformer. Among them, the first primary winding 5 and the first secondary winding 6 of the first transformer are wound on the first main magnetic core column 1, and the second primary winding 9 and the second secondary winding 10 of the second transformer are wound on the second main magnetic core column 2, and the two groups of primary windings and secondary windings are overlapped. The primary winding and the secondary winding overlap each other up and down along the vertical direction of the two main magnetic core columns. The overlapping winding has high mechanical strength, convenient lead, and easy insulation. Meanwhile, this structure can make the winding more compact and improve the efficiency and power density of the transformer.

Further, the first secondary winding 6 and the second secondary winding 10 are connected in series to the first secondary auxiliary winding 11 and the second secondary auxiliary winding 7, respectively. The first secondary auxiliary winding 11 and the second secondary auxiliary winding 7 are overlapped, and the whole winding is arranged on the secondary magnetic core column, that is, winding along the two secondary magnetic core columns to leave a gap between them, and overlapping each other in the vertical direction of the secondary magnetic core column, which is helpful for heat dissipation.

Where the winding direction of the first secondary auxiliary winding 11 and the second secondary auxiliary winding 7 is opposite to the winding direction of the first secondary winding 6 and the second secondary winding 10. For example, the secondary winding is wound counterclockwise on the main magnetic core column; that is, the secondary auxiliary winding is wound clockwise on the secondary magnetic core column. It can make the secondary auxiliary winding and the secondary winding produce the magnetic flux in the same direction in the magnetic core, and jointly bear the demagnetization effect.

Considering the skin effect of the winding at high frequencies, the form of the winding wires is copper foil or Litz wire to minimize the concentrated distribution of current on the surface of the conductor, so as to improve the high-frequency performance of the transformer.

Further, the first main magnetic core column 1, the second main magnetic core column 2, the first secondary magnetic core column 3, the second secondary magnetic core column 8 and the two square magnetic core edge columns 4 all adopt isotropic magnetic materials to ensure that the magnetic core has the same magnetic permeability in different directions, and the magnetic permeability of the main magnetic core column and the secondary magnetic core column is much larger than that of the square magnetic core edge column, so as to realize the decoupling integration of the first transformer and the second transformer.

The first transformer and the second transformer respectively include a main magnetic core column, two secondary magnetic core columns, and half of the upper and lower square magnetic core edge columns connecting the main magnetic core column and the secondary magnetic core column.

Where the first main magnetic core column 1, the second main magnetic core column 2, the first secondary magnetic core column 3 and the second secondary magnetic core column 8 all use high permeability magnetic materials; the square magnetic core edge column 4 uses ordinary magnetic materials (the permeability of ordinary magnetic materials ranges from tens to thousands, while the permeability of high magnetic materials can reach tens of thousands or hundreds of thousands). The main and auxiliary core columns form a low reluctance magnetic circuit. For the first transformer, the magnetic flux generated by the first primary winding is mainly distributed along the low reluctance magnetic circuit. The magnetic flux forms a magnetic flux loop along the direction of the first main magnetic core column—the upper square magnetic core edge column-two auxiliary core columns—the lower square magnetic core edge column—the first main magnetic core column. The second transformer is the same. Therefore, the decoupling integration of two transformers is realized on the magnetic core of this structure. In this way, the power density and efficiency of a high-frequency transformer may be effectively improved on the basis of a small core volume.

The cross-sectional areas of the first main magnetic core column 1, the second main magnetic core column 2, the first secondary magnetic core columns 3 and the second secondary magnetic core columns 8 are the same to ensure uniform magnetic flux density; the width of the square magnetic core edge column 4 is equal to the width of the first main magnetic core column 1, the second main magnetic core column 2, the first secondary magnetic core column 3 and the second secondary magnetic core column 8. The width of the square magnetic core edge column is equal to the width of the main and secondary magnetic core columns. The magnetic flux generated by the winding when energized flows through the main and secondary magnetic core columns and the square magnetic core edge columns, so that the magnetic core material is fully utilized.

As an implementation example, the secondary winding is connected in series with the secondary auxiliary winding, and the two secondary auxiliary windings are overlapped. They are wound on the two auxiliary core columns and placed alternately along the height direction of the auxiliary core column. The leakage reactance X_{σ} generated by the secondary auxiliary winding may be calculated by formula (1):

$${X}_{σ} = 2 π {fN}_{a}^{2} \frac{{μ}_{0} {A}_{0}}{{l}_{0}} \qquad ( 1 )$$

where f is an excitation frequency of the high-frequency transformer, Nₐ denotes coil turns of the secondary auxiliary winding, μ₀ is a permeability of the air, μ₀=4π×10⁻⁷ H/m, A₀ and l₀ are a cross-sectional area of the air magnetic circuit and a length of the air magnetic circuit, respectively.

By adjusting the number of turns of the secondary auxiliary winding, the leakage magnetic flux of the secondary auxiliary winding in the hollow of the magnetic core is adjusted, and then the accurate modulation of the leakage inductance is realized, which effectively avoids the negative effects of loss, heat and noise when the air gap is opened on the magnetic core.

The winding direction of the secondary auxiliary winding is opposite to that of the secondary winding, which ensures that the secondary auxiliary winding and the secondary winding generate the magnetic flux in the same direction in the magnetic core.

The first primary winding turn of the first transformer is Nₚ₁, the first secondary winding turn is Nₛ₁, and the first auxiliary winding turn is Nₐ₁; the secondary auxiliary winding is mainly used to provide leakage inductance, which has little effect on the magnetic flux flowing through the primary winding and the secondary winding in the magnetic core; according to Nₚ₁/(Nₛ₁+Nₐ₁)≈Nₚ₁/Nₛ₁, the voltage ratio of the first transformer is approximately Nₚ₁/Nₛ₁; the second transformer is the same.

### Example 2

A leakage inductance control method for the magnetic core structure of magnetic integrated high-frequency transformer is provided in this disclosure, it is based on the structure described in Example 1, including two square magnetic core edge columns, the first main magnetic core column, the second main magnetic core column, the first secondary magnetic core column and the second secondary magnetic core column, the two square magnetic core edge columns are placed in parallel, the first main magnetic core column and the second main magnetic core column are placed in parallel and vertically in the middle of the two square magnetic core edge columns, and the two ends of the first main magnetic core column and the second main magnetic core column are fixedly connected to the two ends of the two square magnetic core edge columns respectively. The two square magnetic core edge columns are hollowed out in the middle. The first secondary magnetic core column and the second secondary magnetic core column are placed on both sides of the hollow in parallel and vertically, and are fixedly connected to the two square magnetic core edge columns; the two main magnetic core columns and two secondary magnetic core columns are equipped with windings. The square magnetic core edge columns are fixed with the main and secondary magnetic core columns, as the magnetic flux channels connecting the main and secondary magnetic core columns.

As an implementation example, the leakage inductance control method for the magnetic core structure of the magnetic integrated high-frequency transformer includes:

The secondary winding is connected in series with the secondary auxiliary winding, and the two secondary auxiliary windings are overlapped. The whole winding is arranged on two secondary magnetic core columns, which are placed alternately along the height direction of the secondary magnetic core columns.

The leakage reactance X_{σ} generated by the secondary auxiliary winding may be calculated by formula (1):

$${X}_{σ} = 2 π {fN}_{a}^{2} \frac{{μ}_{0} {A}_{0}}{{l}_{0}} \qquad ( 1 )$$

where f is an excitation frequency of the high-frequency transformer, Nₐ denotes coil turns of the secondary auxiliary winding, μ₀ is a permeability of the air, μ₀=4π×10⁻⁷ H/m, A₀ and l₀ are a cross-sectional area of the air magnetic circuit and a length of the air magnetic circuit, respectively.

By adjusting the number of turns of the secondary auxiliary winding, the leakage magnetic flux of the secondary auxiliary winding in the hollow of the magnetic core is adjusted, and then the accurate modulation of the leakage inductance is realized, which effectively avoids the negative effects of loss, heat and noise when the air gap is opened on the magnetic core.

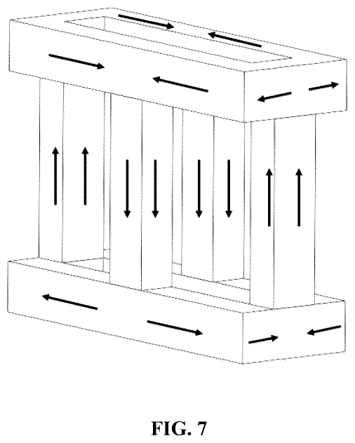

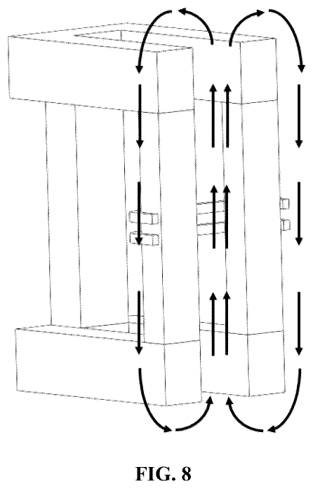

The winding direction of the secondary auxiliary winding is opposite to the winding direction of the secondary winding, which ensures that the secondary auxiliary winding and the secondary winding generate the magnetic flux in the same direction in the magnetic core. As shown in FIG. 7, the magnetic flux of the first transformer forms a magnetic flux loop along the direction of the first main magnetic core column—the upper square magnetic core edge column-two secondary magnetic core columns—the lower square magnetic core edge column—the first main magnetic core column, and the second transformer is the same. As shown in FIG. 8, the leakage magnetic flux generated by the secondary auxiliary winding passes through the hollow of the upper and lower square magnetic core edge columns to form a magnetic flux loop.

The first primary winding turn of the first transformer is Nₚ₁, the first secondary winding turn is Nₛ₁, and the first auxiliary winding turn is Nₐ₁; the secondary auxiliary winding is mainly used to provide leakage inductance, which has little effect on the magnetic flux flowing through the primary winding and the secondary winding in the magnetic core; according to Nₚ₁/(Nₛ₁+Nₐ₁)≈Nₚ₁/Nₛ₁, the voltage ratio of the first transformer is approximately Nₚ₁/Nₛ₁; the second transformer is the same.

This disclosure is described by referring to the flow chart and/or block diagram of the method, equipment (system), and computer program product according to the examples in this disclosure. It should be understood that each process and/or box in the flow chart and/or block diagram may be implemented by computer program instructions, as well as the combination of processes and/or boxes in the flow chart and/or block diagram. These computer program instructions may be provided to general-purpose computers, special-purpose computers, embedded processors, or processors of other programmable data processing devices to generate a machine, so that Instructions that may be executed on a computer or other programmable device provide the steps required to implement the functions specified in a flow diagram or a flow diagram and/or a block diagram or blocks.

These computer program instructions may also be loaded onto a computer or other programmable data processing device, so a series of operation steps are performed on the computer or other programmable device to generate computer-implemented processing, so that the instructions executed on the computer or other programmable device provide the steps for implementing the functions specified in a flow chart or multiple processes and/or a block diagram or multiple blocks.

Although the above-mentioned specific implementations of this disclosure are described in detail combined with the attached figures, they are not limitations to the scope of protection of this disclosure. The technical personnel in the field should understand that, based on the technical scheme of this disclosure, various modifications or deformations made by the technical personnel in the field without paying for creative work are still within the scope of protection of this disclosure.

What is claimed is:

1. A magnetic core structure of a magnetic integrated high-frequency transformer, comprising two square magnetic core edge columns, a first main magnetic core column, a second main magnetic core column, a first secondary magnetic core column and a second secondary magnetic core column; the two square magnetic core edge columns are arranged in parallel, the first main magnetic core column and the second main magnetic core column are placed in parallel and vertically in a middle of the two square magnetic core edge columns, and two ends of the first main magnetic core column and the second main magnetic core column are fixedly connected to two ends of the two square magnetic core edge columns respectively; the two square magnetic core edge columns are hollowed out in the middle; the first magnetic core column and the second secondary magnetic core column are placed on both sides of the hollow in parallel and vertically, and are fixedly connected to the two square magnetic core edge columns, windings are arranged on the two main magnetic core columns and the two secondary magnetic core columns; the square magnetic core edge columns are fixed with the main and secondary magnetic core columns as a magnetic flux channel connecting the main and secondary magnetic core columns;
a first primary winding and a first secondary winding of a first transformer are wound on the first main magnetic core column, and a second primary winding and a second secondary winding of a second transformer are wound on the second main magnetic core column; the two groups of primary windings and secondary windings are overlapped and placed in a vertical direction of the two main magnetic core columns;
the first secondary winding and the second secondary winding are connected in series to the first secondary auxiliary winding and the second secondary auxiliary winding respectively; the first secondary auxiliary winding and the second secondary auxiliary winding are overlapped and arranged on the secondary magnetic core column in a whole, which is overlapped with each other in the vertical direction of the secondary magnetic core column; and
by adjusting the number of turns of the secondary auxiliary windings, the accurate modulation of the leakage inductance is realized, which effectively avoids the negative effects of loss, heat, and noise when an air gap is opened on the magnetic core.

2. The magnetic core structure of the magnetic integrated high-frequency transformer according to claim 1, wherein the first main magnetic core column, the second main magnetic core column, the first secondary magnetic core column, the second secondary magnetic core column and the two square magnetic core edge columns all use isotropic magnetic materials, so that the magnetic core has the same magnetic permeability in different directions, and the magnetic permeability of the main magnetic core column and the secondary magnetic core column is greater than that of the square magnetic core edge column.

3. The magnetic core structure of the magnetic integrated high-frequency transformer according to claim 1, wherein cross-sectional areas of the first main magnetic core column, the second main magnetic core column, the first secondary magnetic core column, and the second secondary magnetic core column are the same.

4. The magnetic core structure of the magnetic integrated high-frequency transformer according to claim 1, wherein a width of the square magnetic core edge column is equal to the widths of the first main magnetic core column, the second main magnetic core column, the first secondary magnetic core column, and the second secondary magnetic core column.

5. The magnetic core structure of the magnetic integrated high-frequency transformer according to claim 1, wherein the winding directions of the first secondary auxiliary winding and the second secondary auxiliary winding are opposite to those of the first secondary winding and the second secondary winding.

6. The magnetic core structure of the magnetic integrated high-frequency transformer according to claim 1, wherein the form of the winding wires is copper foil or Litz wire.

7. A leakage inductance control method for the magnetic core structure of the magnetic integrated high-frequency transformer according to claim 1, wherein a magnetic flux leakage reactance X_{σ} generated by the first secondary auxiliary winding and the second secondary auxiliary winding is calculated as:
$${X}_{σ} = 2 π {fN}_{a}^{2} \frac{{μ}_{0} {A}_{0}}{{l}_{0}}$$
where f is an excitation frequency of the high-frequency transformer, Nₐ denotes coil turns of the secondary auxiliary winding, μ₀ is a permeability of the air, μ₀=4π×10⁻⁷ H/m, A₀ and l₀ are a cross-sectional area of the air magnetic circuit and a length of the air magnetic circuit, respectively.

8. The leakage inductance control method for the magnetic core structure of the magnetic integrated high-frequency transformer according to claim 7, wherein comprising:
by adjusting the number of turns of the secondary auxiliary winding, a leakage magnetic flux of the secondary auxiliary winding in the hollow of the magnetic core is adjusted, and an accurate modulation of the leakage inductance is realized; the first primary winding turn of the first transformer is Nₚ₁, the first secondary winding turn is Nₛ₁, and the first auxiliary winding turn is Nₐ₁; the secondary auxiliary winding is mainly used to provide leakage inductance, which has little effect on the magnetic flux flowing through the primary winding and the secondary winding in the magnetic core; according to Nₚ₁/(Nₛ₁+Nₐ₁)≈Nₚ₁/Nₛ₁, the voltage ratio of the first transformer is approximately Nₚ₁/Nₛ₁; the second transformer is the same.
